(19) United States
(12) Patent Application Publication
(10) Pub. No.: US 2009/0111023 A1
(43) Pub. Date: Apr. 30, 2009

(54) HYDROGEN STORAGE ALLOYS, HYDROGEN STORAGE ALLOY ELECTRODE AND NICKEL METAL HYDRIDE BATTERY USING THE ALLOYS

(75) Inventors: Masaru Kihara, Moriguchi-shi (JP); Takahiro Endo, Takasaki-shi (JP); Akira Saguchi, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/261,749

(22) Filed: Oct. 30, 2008

(30) Foreign Application Priority Data
Oct. 31, 2007 (JP) 2007-283071

(51) Int. Cl. H01M 4/46; C22C 19/03

(52) U.S. Cl. 429/218.2; 420/455

(57) ABSTRACT

A nickel metal hydride battery includes particles of hydrogen storage alloys in the negative electrode. Such hydrogen storage alloys have a composition expressed by a general formula: (LaₐSm_{b}A_{c})_{1-w}Mg_{w}NiₓAl_{y}T_{z}. In the formula, A and T denote at least one element selected from the groups consisting of: Pr, Nd, and the like; and V, Nb, and the like, respectively, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8.

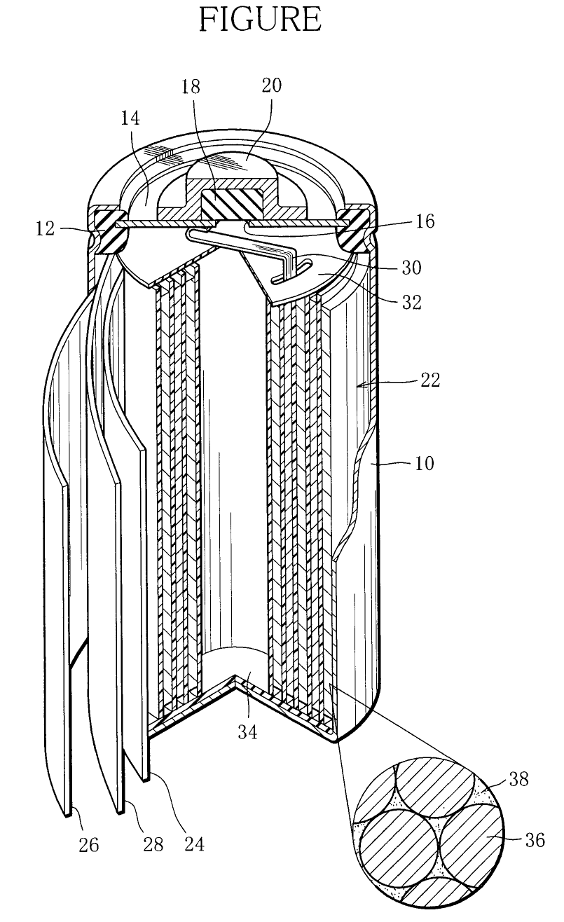

### BACKGROUND OF THE INVENTION

1. Field of the Invention

The present invention relates to hydrogen storage alloys, a hydrogen storage alloy electrode and a nickel metal hydride battery using the alloys.

2. Description of the Related Art

To improve performances of nickel metal hydride batteries, it has been proposed to employ rare earth-Mg—Ni hydrogen storage alloys for negative electrode active materials. Rare earth-Mg—Ni hydrogen storage alloys have a larger hydrogen storage capacity compared to conventionally employed rare earth-Ni hydrogen storage alloys, and thus are suitable for increasing the capacity of nickel metal hydride batteries.

Such rare earth-Mg—Ni hydrogen storage alloys, however, have a low alkali resistance, and caused a problem of reducing cycle life in nickel metal hydride batteries using the alloys. Considering this problem, various examinations of rare earth components have been proposed. For example, Document 1 (Publication of Japanese Patent No. 3,913,691) and Document 2 (Japanese Unexamined Patent Publication No. 2005-290473) disclose reduction in La content and increase in Pr and Nd contents.

The rare earth-Mg—Ni hydrogen storage alloys disclosed in Documents 1 and 2 have an excellent alkali resistance, and nickel metal hydride batteries using these alloys have an improved cycle life for charging and discharging.

In the rare earth-Mg—Ni hydrogen storage alloys disclosed in Documents 1 and 2, however, the hydrogen storage capacity is reduced and the hydrogen equilibrium pressure is increased, and thus the internal pressure of battery is prone to be increased. This is because a reduction in La content reduces the hydrogen storage capacity, which leads to an increase in hydrogen equilibrium pressure.

### SUMMARY OF THE INVENTION

An object of the present invention is to provide a rare earth-Mg—Ni hydrogen storage alloy that is excellent in the alkali resistance in spite of a high La content and low Pr and Nd contents, and a hydrogen storage alloy electrode using the alloy, thereby providing a nickel metal hydride battery using the rare earth-Mg—Ni hydrogen storage alloy and having a large capacity and a long cycle life.

According to one aspect of the present invention, a hydrogen storage alloy is provided that has a composition expressed by a general formula:

(LaₐSm_{b}A_{c})_{1-w}Mg_{w}NiₓAl_{y}T_{z},

wherein A denotes at least one element selected from the group consisting of Pr, Nd, Pm, Eu, Gd, Tb, Dy, Ho, Er, Tm, Yb, Lu, Sc, Zr, Hf, Ca, and Y, T denotes at least one element selected from the group consisting of V, Nb, Ta, Cr, Mo, Mn, Fe, Co, Al, Ga, Zn, Sn, In, Cu, Si, P, and B, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8.

Since the hydrogen storage alloy according to this aspect of the present invention has the predetermined composition containing La and Sm, it has a large hydrogen storage capacity, a low hydrogen equilibrium pressure, and good alkali resistance.

The subscripts a and b preferably satisfy the relationship given by a>b.

Since the subscript a indicating the La content has a larger value than the subscript b indicating the Sm content, the hydrogen storage alloy according to this preferred aspect has a particularly large hydrogen storage capacity. Accordingly, nickel metal hydride batteries having a hydrogen storage alloy electrode using the hydrogen storage alloy are particularly excellent in cycle life.

The subscript a is preferably 0.5 or more.

Since the subscript a indicating the La content is 0.5 or more, the hydrogen storage alloy according to this preferred aspect has a particularly large hydrogen storage capacity. Accordingly, nickel metal hydride batteries having a hydrogen storage alloy electrode using the hydrogen storage alloy are particularly excellent in cycle life.

The subscript c is preferably 0.02 or less.

Since the subscript c indicating the content of the element denoted by A is 0.02 or less, the hydrogen storage alloy according to this preferred aspect has a particularly large hydrogen storage capacity. Accordingly, nickel metal hydride batteries having a hydrogen storage alloy electrode using the hydrogen storage alloy are particularly excellent in cycle life.

The subscript w preferably satisfies the relationship given by 0.10≦w≦0.30.

Since the subscript w indicating the Mg content satisfies the relationship given by 0.10≦w≦0.30, the hydrogen storage alloy according to the preferred aspect has a hydrogen storage capacity and a hydrogen equilibrium pressure kept within an appropriate range. Accordingly, nickel metal hydride batteries having a hydrogen storage alloy electrode using the hydrogen storage alloy are particularly excellent in cycle life.

According to another aspect of the present invention, a hydrogen storage alloy electrode is provided that comprises particles consisting of any of the hydrogen storage alloys above, and an electrically conductive core maintaining the particles.

According to still another aspect of the present invention, a nickel metal hydride battery is provided that comprises the above hydrogen storage alloy electrode as a negative electrode.

The nickel metal hydride battery according to another aspect of the present invention has an appropriate operating voltage and is excellent in cycle life.

### BRIEF DESCRIPTION OF THE DRAWINGS

The present invention will become more fully understood from the detailed description given hereinbelow and the accompanying drawing which is given by way of illustration only, and thus, is not limitative of the present invention, and wherein:

FIGURE is a partially cut out perspective view showing a nickel metal hydride battery according to one embodiment of the present invention, and the circle shows an enlarged schematic partial view of a negative electrode.

### DETAILED DESCRIPTION

To achieve the objects above, the present inventors keenly made thorough examinations of means for ensuring the alkali resistance of rare earth-Mg—Ni hydrogen storage alloys even with composition having a high La content and low Pr and Nd contents.

During the course of examinations, the present inventors have found that, by including a large amount of La, to maintain a high hydrogen storage capacity, and also including Sm together in rare earth-Mg—Ni hydrogen storage alloys, the hydrogen equilibrium pressure reduced with the increase in La content can be raised to the level possible to be used as a battery and that such composition ensures the alkali resistance sufficient for a battery, and thus realized the present invention.

Hereinbelow, a nickel metal hydride battery according to one embodiment of the present invention is described in detail.

This battery is, for example, an AA size cylindrical battery, and as shown in FIGURE, provided with a housing can 10 having a cylindrical shape with an open top end and a closed bottom. The bottom wall of the housing can 10 is electrically conductive and functions as a negative electrode terminal. In the opening of the housing can 10, an electrically conductive disc shaped cover plate 14 is disposed via a ring shaped insulating packing 12, and the cover plate 14 and the insulating packing 12 are fixed on an opening edge of the housing can 10 by caulking the opening edge of the housing can 10.

The cover plate 14 has a vent hole 16 in the center, and a rubber valve 18 is disposed on the outer face of the cover plate 14 to block the vent hole 16. Further on the outer face of the cover plate 14, a positive electrode terminal 20 of a cylindrical shape with a flange is fixed to cover the valve 18, and the positive electrode terminal 20 presses the valve 18 on the cover plate 14. Accordingly, the housing can 10 is normally air tight sealed on the insulating packing 12 and the valve 18 by the cover plate 14. In contrast, when a gas is generated in the housing can 10 and the internal pressure is increased, the valve 18 is compressed and the gas is released from the housing can 10 through the vent hole 16. In other words, the cover plate 14, valve 18, and positive electrode terminal 20 form a safety valve.

The housing can 10 contains an electrode assembly 22. The electrode assembly 22 consists of a positive electrode 24, a negative electrode 26, and a separator 28, each in strip form, and the separator 28 is sandwiched between the positive and negative electrodes 24 and 26 wound in spiral. That is, the positive electrode 24 and negative electrode 26 overlap each other via the separator 28. The outermost perimeter of the electrode assembly 22 is formed of a part (an outermost perimeter part) of the negative electrode 26, and by making the outermost perimeter part of the negative electrode 26 in contact with the inner wall of the housing can 10, the negative electrode 26 and the housing can 10 are electrically connected with each other. It should be noted that further description is given later for the positive electrode 24, negative electrode 26, and separator 28.

In the housing can 10, a positive electrode lead 30 is disposed between the cover plate 14 and an end of the electrode assembly 22, and both ends of the positive electrode lead 30 are connected to the positive electrode 24 and cover plate 14, respectively. Accordingly, the positive electrode terminal 20 and positive electrode 24 are electrically connected via the positive electrode lead 30 and the cover plate 14. A circular insulating member 32 is disposed between the cover plate 14 and electrode assembly 22, and the positive electrode lead 30 extends through a slit provided in the insulating member 32. In addition, a circular insulating member 34 is also disposed between the electrode assembly 22 and the bottom of the housing can 10.

Further in the housing can 10, a predetermined amount of an alkaline electrolyte (not shown) is injected to proceed the charge and discharge reactions between the positive electrode 24 and negative electrode 26 through the alkaline electrolyte included in the separator 28. The type of alkaline electrolyte is not particularly limited, and may include, for example, an aqueous sodium hydroxide solution, an aqueous lithium hydroxide solution, an aqueous potassium hydroxide solution, and an aqueous solution obtained by mixing two or more of these. The concentration of alkaline electrolyte is not particularly limited, either, and an alkaline electrolyte of 8N, for example, may be used.

For a material of the separator 28, for example, a non-woven fabric of polyamide fibers, and a non-woven fabric of polyolefin fibers such as of polyethylene and polypropylene provided with a hydrophilic functional group may be employed.

The positive electrode 24 is constituted by an electrically conductive positive electrode substrate having a porous structure and a positive electrode mixture maintained in the holes of the positive electrode substrate. The positive electrode mixture includes positive electrode active material particles, particles of various additives for improving the properties of the positive electrode 24 as needed, and a binder for binding mixed particles of the positive electrode active material particles and additive particles to the positive electrode substrate.

It should be noted that, since this battery is a nickel metal hydride battery, the positive electrode active material particles are nickel hydroxide particles and such nickel hydroxide particles may contain cobalt, zinc, cadmium, and the like in the form of a solid solution or may be coated with a cobalt compound alkali-heat treated on the surface. They are not particularly limited, and for such additives, other than yttrium oxide: cobalt compounds, such as cobalt oxide, metal cobalt, and cobalt hydroxide; zinc compounds, such as metal zinc, zinc oxide, and zinc hydroxide; and rare earth compounds, such as erbium oxide may be employed, and for such binders, hydrophilic or hydrophobic polymers may be employed.

The negative electrode 26 has an electrically conductive negative electrode substrate (core) in strip form, and the negative electrode substrate maintains a negative electrode mixture. The negative electrode substrate is made of a metal material in sheet form with through holes distributed, and for example, perforated metals and metal powder sintered substrates made by molding metal powders and then sintering may be employed. Accordingly, the negative electrode mixture is filled in the through holes of the negative electrode substrate and also maintained on both faces of the negative electrode substrate in layer form.

The negative electrode mixture is schematically shown in the circle in FIGURE, and includes hydrogen storage alloy particles 36, capable of storing and releasing hydrogen as a negative electrode active material, conductive aids (not shown), such as carbon, as needed, and a binder 38, binding the hydrogen storage alloys and conductive aids to the negative electrode substrate. For the binder 38, for example, hydrophilic or hydrophobic polymers may be employed, and for the conductive aids, carbon black and graphite may be employed. It should be noted that the negative electrode capacity is determined by the amount of hydrogen storage alloys in a case that the active material is hydrogen. Thus, in the present invention, the hydrogen storage alloys also may be referred to as negative electrode active materials and the negative electrode 26 also may be referred to as a hydrogen storage alloy electrode.

The hydrogen storage alloys in the hydrogen storage alloy particles 36 of this battery are rare earth-Mg—Ni hydrogen storage alloys, having a main crystal structure of a superlattice structure, not of CaCu₅, but incorporating the AB₅ structure and the AB₂ structure, and the composition is expressed by a general formula:

(LaₐSm_{b}A_{c})_{1-w}Mg_{w}NiₓAl_{y}T_{z} (1)

In Formula (1), A denotes at least one element selected from the group consisting of Pr, Nd, Pm, Eu, Gd, Tb, Dy, Ho, Er, Tm, Yb, Lu, Sc, Zr, Hf, Ca, and Y, T denotes at least one element selected from the group consisting of V, Nb, Ta, Cr, Mo, Mn, Fe, Co, Al, Ga, Zn, Sn, In, Cu, Si, P, and B, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8.

It should be noted that, in the superlattice structure, Mg and the elements given by La, Sm, and A occupy site A, and the elements given by Ni, Al, and T occupy site B. In the present specification, among the elements occupying site A, the elements given by La, Sm, and A also may be referred to as rare earth components.

The hydrogen storage alloy particles 36 may be obtained, for example, in the following manner.

First, the metal materials are weighted and mixed to obtain the above composition, and the mixture is melted, for example, in a high frequency furnace to obtain an ingot. The ingot thus obtained is heat treated by heating in an inert gas atmosphere at temperatures from 900 to 1200° C. for 5 to 24 hours to obtain a superlattice structure incorporating the AB₅ structure and the AB₂ structure of the metal structure of the ingot. After that, the ingot is ground and classified into desired particle diameters by sieving, and thus hydrogen storage alloy particles 36 can be obtained.

Since the hydrogen storage alloy particles 36 contain rare earth-Mg—Ni hydrogen storage alloys as the main components, the nickel metal hydride battery described above has a high capacity.

Moreover, since the rare earth-Mg—Ni hydrogen storage alloys employed for the nickel metal hydride battery have the predetermined composition including La and Sm, they have a large hydrogen storage capacity, a low hydrogen equilibrium pressure, and a good alkali resistance. The nickel metal hydride battery having a hydrogen storage alloy electrode using such hydrogen storage alloy as the negative electrode 26 is, therefore, excellent in cycle life.

### EXAMPLES

### 1. Battery Assembly

### Example 1

### (1) Fabrication of Negative Electrode

Raw materials of rare earth components were prepared to have a breakdown of the rare earth components of, in terms of the ratio of the number of atoms, 40% La, 52% Sm, and 8% Zr, and a bulk of a hydrogen storage alloy was prepared, using an induction furnace, that contain the raw materials of rare earth components, Mg, Ni, and Al at the proportion of 0.85:0.15:3.5:0.1 in terms of the ratio of the number of atoms. The alloy was heat treated in an argon atmosphere at 1000° C. for 10 hours to obtain an ingot of rare earth-Mg—Ni hydrogen storage alloy having a superlattice structure with a composition expressed by (La0.40Sm0.52Zr0.08)0.85Mg0.15Ni3.5Al0.1.

The rare earth-Mg—Ni hydrogen storage alloy ingot was mechanically ground in an inert gas atmosphere, and alloy particles with diameters within the range of 400 to 200 mesh were screened by sieving. The particle size distribution of the alloy particles was measured with a laser diffraction/light scattering particle size distribution analyzer, to find that the average particle diameter corresponding to 50% of the convolution weight integrationl was 30 (m and the maximum particle diameter was 45 (m.

After adding 0.4 parts by mass of sodium polyacrylate, 0.1 parts by mass of carboxymethylcellulose, 2.5 parts by mass of polytetrafluoroethylene dispersion liquid (dispersion medium: water, 60 parts by mass of solid content), and 1 part by mass of metal Sn (tin) to 100 parts by mass of the alloy particles, it was kneaded to obtain a slurry of negative electrode mixture.

The slurry was coated uniformly in a constant thickness on the entire surfaces of both faces of a Ni plated Fe perforated metal having a thickness of 60 μm. After drying the slurry, the perforated metal was pressed and cut to fabricate a negative electrode for an AA size nickel metal hydride battery.

### (2) Fabrication of Positive Electrode

A mixed aqueous solution of nickel sulfate, zinc sulfate, and cobalt sulfate was prepared, having the ratio of 3 weight % Zn and 1 weight % Co to metal Ni, and an aqueous sodium hydroxide solution was gradually added to the mixed aqueous solution while stirred. During the process, nickel hydroxide particles were precipitated while maintaining the pH from 13 to 14 during the reaction, and after washing the nickel hydroxide particles with 10 parts pure water three times, they were dewatered and dried.

The nickel hydroxide particles thus obtained were mixed with 40 weight % of HPC dispersion liquid to prepare a slurry of positive electrode mixture. After filling the slurry into a nickel substrate having a porous structure and drying, the substrate was rolled and cut to fabricate a positive electrode for an AA size nickel metal hydride battery.

### (3) Assembly of Nickel Metal Hydride Battery

The negative and positive electrodes thus obtained were wound in spiral via a separator made of a polypropylene or nylon non-woven fabric to form an electrode assembly, and after containing the electrode assembly in a housing can, an aqueous potassium hydroxide solution with a concentration of 30 weight % containing lithium and sodium was injected into the housing can to assembly an AA size nickel metal hydride battery having a battery structured as shown in FIGURE and a nominal capacity of 2700 mAh.

### Example 2

A nickel metal hydride battery was assembled in the same manner as Example 1 other than the composition of hydrogen storage alloy being (La_{0.46}Sm_{0.46}Zr_{0.08})_{0.85}Mg_{0.15}Ni_{3.5}Al_{0.1}.

### Example 3

A nickel metal hydride battery was assembled in the same manner as Example 1 other than the composition of hydrogen storage alloy being (La_{0.48}Sm_{0.44}Zr_{0.08})_{0.85}Mg_{0.15}Ni_{3.5}Al_{0.1}.

### Example 4

A nickel metal hydride battery was assembled in the same manner as Example 1 other than the composition of hydrogen storage alloy being (La_{0.52}Sm_{0.40}Zr_{0.08})_{0.85}Mg_{0.15}Ni_{3.5}Al_{0.1}.

### Example 5

A nickel metal hydride battery was assembled in the same manner as Example 1 other than the composition of hydrogen storage alloy being (La_{0.80}Sm_{0.12}Zr_{0.08})_{0.85}Mg_{0.15}Ni_{3.5}Al_{0.1}.

### Example 6

A nickel metal hydride battery was assembled in the same manner as Example 1 other than the composition of hydrogen storage alloy being (La_{0.80}Sm_{0.16}Zr_{0.04})_{0.85}Mg_{0.15}Ni_{3.5}Al_{0.1}.

### Example 7

A nickel metal hydride battery was assembled in the same manner as Example 1 other than the composition of hydrogen storage alloy being (La_{0.80}Sm_{0.18}Zr_{0.02})_{0.85}Mg_{0.15}Ni_{3.5}Al_{0.1}.

### Example 8

A nickel metal hydride battery was assembled in the same manner as Example 1 other than the composition of hydrogen storage alloy being (La_{0.40}Sm_{0.52}Zr_{0.08})_{0.70}MgC_{0.30}Ni_{3.5}Al_{0.1}.

### Example 9

A nickel metal hydride battery was assembled in the same manner as Example 1 other than the composition of hydrogen storage alloy being (La_{0.40}Sm_{0.52}Zr_{0.08})_{0.90}Mg_{0.10}Ni_{3.5}Al_{0.1}.

### Example 10

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.55}Al_{0.05}.

### Example 11

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.15}Al_{0.35}.

### Example 12

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.10}Al_{0.10}.

### Example 13

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.70}Al_{0.10}.

### Comparative Example 1

A nickel metal hydride battery was assembled in the same manner as Example 1 other than the composition of hydrogen storage alloy being (La_{0.40}Ce_{0.52}Zr_{0.08})_{0.85}Mg_{0.15}Ni_{3.5}Al_{0.1}.

### Comparative Example 2

A nickel metal hydride battery was assembled in the same manner as Example 1 other than the composition of hydrogen storage alloy being (La_{0.40}Pr_{0.52}Zr_{0.08})_{0.85}Mg_{0.15}Ni_{3.5}Al_{0.1}.

### Comparative Example 3

A nickel metal hydride battery was assembled in the same manner as Example 1 other than the composition of hydrogen storage alloy being (La_{0.40}Pr_{0.52}Zr_{0.08})_{0.85}Mg_{0.15}Ni_{3.5}Al_{0.1}.

### Comparative Example 4

A nickel metal hydride battery was assembled in the same manner as Example 1 other than the composition of hydrogen storage alloy being (La_{0.40}Pr_{0.52}Zr_{0.10})_{0.85}Mg_{0.15}Ni_{3.5}Al_{0.1}.

### Comparative Example 5

A nickel metal hydride battery was assembled in the same manner as Example 1 other than the composition of hydrogen storage alloy being (La_{0.40}Pr_{0.52}Zr_{0.08})_{0.78}Mg_{0.32}Ni_{3.5}Al_{0.1}.

### Comparative Example 6

A nickel metal hydride battery was assembled in the same manner as Example 1 other than the composition of hydrogen storage alloy being (La_{0.40}Sm_{0.52}Zr_{0.08})_{0.92}Mg_{0.08}Ni_{3.5}Al_{0.1}.

### Comparative Example 7

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.57}Al_{0.03}.

### Comparative Example 8

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.13}Al_{0.37}.

### Comparative Example 9

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.05}Al_{0.10}.

### Comparative Example 10

A nickel metal hydride battery was assembled in the same manner as Example 1 other than the composition of hydrogen storage alloy being (La_{0.40}Sm_{0.52}Zr_{0.08})_{0.85}Mg_{0.15}Ni_{3.75}Al_{0.1}.

### 2. Method of Battery Evaluation

### (1) Maximum Internal Pressure of Battery

Each battery of Examples 1 through 13 and Comparative Examples 1 through 10 was measured for the maximum internal pressure of the battery charged with a current of 0.5 C up to a charge depth of 480% (maximum internal pressure). The results are shown in Tables 1 and 2.

It should be noted that Tables 1 and 2 show composition of the hydrogen storage alloys as well as the ratios of the number of elements in site B to the number of elements in site A (B/A ratio).

### (2) Operating Voltage

Each battery of Examples 1 through 13 and Comparative Examples 1 through 10 was measured for the intermediate operating voltage when charged with a current of 0.1 C for 16 hours and then discharged at a current of 0.2 C. The results are shown in Tables 1 and 2 as differences (unit: mV) from the intermediate operating voltage in Example 1.

### (3) Cycle Life

For each battery of Examples 1 through 13 and Comparative Examples 1 through 10, counting was carried out on the number of cycles until the battery became incapable of discharging (cycle life) by repeating battery capacity measurements of charging with a current of 1.0 C for one hour and then discharging at a current of 1.0 C until the final voltage of 0.8 V. The results are shown in Tables 1 and 2 referring to the result of Example 1 as 100.

### (4) Effective Hydrogen Storage Capacity and Hydrogen Storage Pressure

Each hydrogen storage alloy used in Examples 1 through 13 and Comparative Examples 1 through 10 was measured for the pressure-composition isotherm under hydrogen pressure at 80° C. by the Sieverts' method to obtain an effective hydrogen storage capacity (H/M) and a hydrogen pressure during storing hydrogen at H/M=0.5 (hydrogen storage pressure). The results are shown in Tables 1 and 2.

TABLE 1

| | | | Effective | | | | |
|---|---|---|---|---|---|---|---|
| | | | Hydrogen | Hydrogen | Maximum | Operating | |
| | Hydrogen Storage Alloy | | Storage | Storage | Internal | Voltage | |
| | | B/A | Capacity | Pressure | Pressure | Difference | Cycle |
| | Composition | ratio | (H/M) | (MPa) | (MPa) | (mV) | Life |
| Example 1 | (La_{0.40}Sm_{0.52}Zr_{0.08})_{0.85}Mg_{0.15}Ni_{3.5}Al_{0.1} | 3.60 | 0.915 | 0.190 | 0.71 | 0 | 100 |
| Example 2 | (La_{0.46}Sm_{0.46}Zr_{0.08})_{0.85}Mg_{0.15}Ni_{3.5}Al_{0.1} | 3.60 | 0.918 | 0.160 | 0.67 | −2 | 102 |
| Example 3 | (La_{0.48}Sm_{0.44}Zr_{0.08})_{0.85}Mg_{0.15}Ni_{3.5}Al_{0.1} | 3.60 | 0.920 | 0.140 | 0.65 | −4 | 105 |
| Example 4 | (La_{0.52}Sm_{0.40}Zr_{0.08})_{0.85}Mg_{0.15}Ni_{3.5}Al_{0.1} | 3.60 | 0.925 | 0.120 | 0.62 | −6 | 120 |
| Example 5 | (La_{0.80}Sm_{0.12}Zr_{0.08})_{0.85}Mg_{0.15}Ni_{3.5}Al_{0.1} | 3.60 | 0.930 | 0.090 | 0.60 | −9 | 125 |
| Example 6 | (La_{0.80}Sm_{0.16}Zr_{0.04})_{0.85}Mg_{0.15}Ni_{3.5}Al_{0.1} | 3.60 | 0.930 | 0.089 | 0.58 | −10 | 126 |
| Example 7 | (La_{0.80}Sm_{0.18}Zr_{0.02})_{0.85}Mg_{0.15}Ni_{3.5}Al_{0.1} | 3.60 | 0.930 | 0.088 | 0.58 | −10 | 160 |
| Example 8 | (La_{0.40}Sm_{0.52}Zr_{0.08})_{0.70}Mg_{0.30}Ni_{3.5}Al_{0.1} | 3.60 | 0.925 | 0.210 | 0.88 | 1 | 98 |
| Example 9 | (La_{0.40}Sm_{0.52}Zr_{0.08})_{0.90}Mg_{0.10}Ni_{3.5}Al_{0.1} | 3.60 | 0.890 | 0.175 | 1.18 | −1 | 97 |
| Example 10 | (La_{0.40}Sm_{0.52}Zr_{0.08})_{0.85}Mg_{0.15}Ni_{3.55}Al_{0.05} | 3.60 | 0.940 | 0.240 | 0.85 | 3 | 90 |
| Example 11 | (La_{0.40}Sm_{0.52}Zr_{0.08})_{0.85}Mg_{0.15}Ni_{3.15}Al_{0.35} | 3.50 | 0.850 | 0.092 | 1.21 | −9 | 101 |
| Example 12 | (La_{0.40}Sm_{0.52}Zr_{0.08})_{0.85}Mg_{0.15}Ni_{3.10}Al_{0.10} | 3.20 | 0.870 | 0.085 | 1.07 | −10 | 102 |
| Example 13 | (La_{0.40}Sm_{0.52}Zr_{0.08})_{0.85}Mg_{0.15}Ni_{3.70}Al_{0.10} | 3.80 | 0.910 | 0.270 | 0.87 | 4 | 98 |

TABLE 2

| | | | Effective | | | | |
|---|---|---|---|---|---|---|---|
| | | | Hydrogen | Hydrogen | Maximum | Operating | |
| | Hydrogen Storage Alloy | | Storage | Storage | Internal | Voltage | |
| | | B/A | Capacity | Pressure | Pressure | Difference | Cycle |
| | Composition | ratio | (H/M) | (MPa) | (MPa) | (mV) | Life |
| Comparative | (La_{0.40}Ce_{0.52}Zr_{0.08})_{0.85}Mg_{0.15}Ni_{3.5}Al_{0.1} | 3.60 | 0.755 | 0.180 | 2.56 | −1 | 50 |
| Example 1 | | | | | | | |
| Comparative | (La_{0.40}Pr_{0.52}Zr_{0.08})_{0.85}Mg_{0.15}Ni_{3.5}Al_{0.1} | 3.60 | 0.915 | 0.091 | 0.66 | −9 | 95 |
| Example 2 | | | | | | | |
| Comparative | (La_{0.40}Nd_{0.52}Zr_{0.08})_{0.85}Mg_{0.15}Ni_{3.5}Al_{0.1} | 3.60 | 0.915 | 0.100 | 0.69 | −8 | 90 |
| Example 3 | | | | | | | |
| Comparative | (La_{0.40}Sm_{0.50}Zr_{0.10})_{0.85}Mg_{0.15}Ni_{3.5}Al_{0.1} | 3.60 | 0.910 | 0.191 | 0.75 | 0 | 70 |
| Example 4 | | | | | | | |
| Comparative | (La_{0.40}Sm_{0.52}Zr_{0.08})_{0.68}Mg_{0.32}Ni_{3.5}Al_{0.1} | 3.60 | 0.930 | 0.212 | 1.16 | 1 | 55 |
| Example 5 | | | | | | | |
| Comparative | (La_{0.40}Sm_{0.52}Zr_{0.08})_{0.92}Mg_{0.08}Ni_{3.5}Al_{0.1} | 3.60 | 0.800 | 0.160 | 2.25 | −2 | 60 |
| Example 6 | | | | | | | |
| Comparative | (La_{0.40}Sm_{0.52}Zr_{0.08})_{0.85}Mg_{0.15}Ni_{3.57}Al_{0.03} | 3.60 | 0.945 | 0.248 | 1.20 | 3 | 20 |
| Example 7 | | | | | | | |
| Comparative | (La_{0.40}Sm_{0.52}Zr_{0.08})_{0.85}Mg_{0.15}Ni_{3.13}Al_{0.37} | 3.50 | 0.605 | 0.081 | 2.95 | −11 | 45 |
| Example 8 | | | | | | | |
| Comparative | (La_{0.40}Sm_{0.52}Zr_{0.08})_{0.85}Mg_{0.15}Ni_{3.05}Al_{0.10} | 3.15 | 0.865 | 0.079 | 2.68 | −11 | 75 |
| Example 9 | | | | | | | |
| Comparative | (La_{0.40}Sm_{0.52}Zr_{0.08})_{0.85}Mg_{0.15}Ni_{3.75}Al_{0.1} | 3.85 | 0.900 | 0.277 | 1.39 | 5 | 65 |
| Example 10 | | | | | | | |

### 3. Results of Battery Evaluation

The following is obvious from Tables 1 and 2.

(1) Although Comparative Example 1 in which the rare earth-Mg—Ni hydrogen storage alloy contains Ce has a hydrogen storage pressure (hydrogen equilibrium pressure) and an operating voltage not greatly different from Example 1 in which the rare earth-Mg—Ni hydrogen storage alloy contains Sm, Comparative Example 1 has seriously reduced effective hydrogen storage capacity and cycle life, and a seriously increased battery internal pressure. The reduction in cycle life in Comparative Example 1 is considered to be caused by shortage of the alkaline electrolyte in the battery after the alkaline electrolyte leaked out as a result of increase in the battery internal pressure due to the reduction in effective hydrogen storage capacity of the rare earth-Mg—Ni hydrogen storage alloy.
(2) Although Comparative Examples 1 and 2 in which the rare earth-Mg—Ni hydrogen storage alloys contain Pr or Nd, have maximum internal pressures of the batteries not greatly different from Example 1 in which the rare earth-Mg—Ni hydrogen storage alloy contains Sm, Comparative Examples 1 and 2 have short cycle lives. This is considered to be caused by the fact that the rare earth-Mg—Ni hydrogen storage alloy containing Sm has alkali resistance equivalent to or greater than the rare earth-Mg—Ni hydrogen storage alloys including Pr or Nd.
(3) Example 1 in which the rare earth-Mg—Ni hydrogen storage alloy contains Sm had an operating voltage higher than those of Comparative Examples 1, 2, and 3 containing Ce, Pr, or Nd. This is considered to be caused by the higher hydrogen storage pressure in the rare earth-Mg—Ni hydrogen storage alloy containing Sm.
(4) Based on Examples 1 through 3, the ratio of La to Sm is discussed. When the La content becomes higher than the Sm content, the cycle life is improved. Accordingly, the subscript a of La is desirably larger than the subscript b of Sm (a>b). The subscript b of Sm is also desirably 0.40 or less.
(5) Based on Examples 2 through 5, the content of La is discussed. According to the comparison among Examples 2, 3, and 4, when the proportion of La in the rare earth components becomes half or more in terms of the ratio of the number of atoms, the cycle life is remarkably improved. Therefore, the proportion of La in the rare earth components is desirably 50% or more (a≧0.5) in terms of the ratio of the number of atoms.

It should be noted that, according to the comparison between Examples 4 and 5, when the proportion of La in the rare earth components is further increased more than half, the cycle life is not so greatly improved while it reduces the hydrogen storage pressure, causing a reduction in operating voltage. The subscript a is, therefore, desirably 0.80 or less.

(6) Based on Examples 1, 6, and 7 and Comparative Example 4, the amounts of the components other than La and Sm in the rare earth components, in other words the amount of the elements given by A, are discussed. Example 6 in which the proportion of Zr is, in terms of the ratio of the number of atoms, 4% in the rare earth components has an improved cycle life compared to Example 1 in which the proportion of Zr is 8% (c=0.08). In addition, Example 7 in which the proportion of Zr is 2% (c=0.02) has a further improved cycle life compared to Example 6. In contrast, Comparative Example 4 in which the proportion of Zr is 0.10% has a reduced cycle life compared to Example 1.

Accordingly, the contents of the components other than La and Sm in the rare earth components is set to less than 10% (c<0.10) in terms of the ratio of the number of atoms, and is desirably set to 2% or less (c≦0.02).

(7) Based on Examples 8 and 9 and Comparative Examples 5 and 6, the content of Mg is discussed. According to the comparison between Example 8 and Comparative Example 5, when the proportion of Mg in site A exceeds 30% in terms of the ratio of the number of atoms, the cycle life is reduced remarkably. According to the comparison between Examples 9 and 6, when the proportion of Mg in site A becomes less than 10% in terms of the ratio of the number of atoms, the cycle life is also reduced remarkably. The proportion of Mg in site A is, therefore, desirably set from 10% or more to 30% or less (0.10≦w≦0.30) in terms of the ratio of the number of atoms. It should be noted that the proportion is more desirably set from 10% or more to 20% or less (0.10≦w≦0.20).
(8) Based on Examples 10 and 11 and Comparative Examples 7 and 8, the content of Al is discussed. According to the comparison between Example 10 and Comparative Example 7, when the subscript y of Al becomes less than 0.05, the cycle life is reduced remarkably. This is considered to be caused by the proceeding of the oxidation reaction of the rare earth-Mg—Ni hydrogen storage alloy by the alkaline electrolyte due to the content of Al functioning to inhibit oxidation of rare earth-Mg—Ni hydrogen storage alloys having been too low. According to the comparison between Example 11 and Comparative Example 8, when the subscript y of Al exceeds 0.35, the effective hydrogen storage capacity is reduced seriously and thus the cycle life is also reduced remarkably. The subscript y of Al is, therefore, set within the range given by 0.05≦y≦0.35. It should be noted that the subscript y is desirably set within the range given by 0.10≦y≦0.20.
(9) Based on Examples 12 and 13 and Comparative Examples 9 and 10, the ratio of B/A is discussed. According to the comparison between Example 12 and Comparative Example 9, when the B/A ratio is less than 3.20, the operating voltage is reduced and the cycle life is also reduced remarkably. According to the comparison between Example 13 and Comparative Example 10, when the B/A ratio exceeds 3.8, the cycle life is reduced remarkably. The B/A ratio is, therefore, set from 3.2 or more to 3.8 or less. In other words, the subscripts x, y, and z are set to satisfy the relationship given by 3.2≦x+y+z≦3.8. It should be noted that the subscripts x, y, and z are desirably set to satisfy the relationship given by 3.3≦x+y+z≦3.6.
(10) As described above, the hydrogen storage alloys according to the present invention maintain a large hydrogen storage capacity by employing a large amount of La, and maintain the hydrogen equilibrium pressure at a level possible to be used as a nickel metal hydride battery by employing Sm at the same time to ensure the alkali resistance. By using the hydrogen storage alloys according to the present invention, a reasonably priced nickel metal hydride battery having excellent cycle properties can be obtained, and thus the present invention demonstrates extremely high industrial value.

The present invention is not limited to one embodiment and Examples described above, but includes various modifications in which, for example, the nickel metal hydride battery also may be a square battery and the mechanical structure is not limited in particular.

In one embodiment above, the reason why the subscript z of the elements given by T is set within the range of 0≦z≦0.5 is to ensure the hydrogen storage capacity of the rare earth-Mg—Ni hydrogen storage alloys.

The hydrogen storage alloys and the hydrogen storage alloy electrode of the present invention are, needless to say, applicable to articles other than nickel metal hydride batteries.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hydrogen storage alloy, comprising a composition expressed by a general formula:
(LaₐSm_{b}A_{c})_{1-w}Mg_{w}NiₓAl_{y}T_{z},
wherein A denotes at least one element selected from the group consisting of Pr, Nd, Pm, Eu, Gd, Tb, Dy, Ho, Er, Tm, Yb, Lu, Sc, Zr, Hf, Ca, and Y, T denotes at least one element selected from the group consisting of V, Nb, Ta, Cr, Mo, Mn, Fe, Co, Al, Ga, Zn, Sn, In, Cu, Si, P, and B, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8.

2. The hydrogen storage alloy according to claim 1, wherein the subscripts a and b satisfy the relationship given by a>b.

3. The hydrogen storage alloy according to claim 2, wherein the subscript a is 0.5 or more.

4. The hydrogen storage alloy according to claim 3, wherein the subscript c is 0.02 or less.

5. The hydrogen storage alloy according to claim 4, wherein the subscript w satisfies the relationship given by 0.10≦w≦0.30.

6. The hydrogen storage alloy according to claim 1, wherein the subscript w satisfies the relationship given by 0.10≦w≦0.30.

7. A hydrogen storage alloy electrode comprising:
particles made of the hydrogen storage alloy, the alloy having a composition expressed by a general formula:
(LaₐSm_{b}A_{c})_{1-w}Mg_{w}NiₓAl_{y}T_{z},
wherein A denotes at least one element selected from the group consisting of Pr, Nd, Pm, Eu, Gd, Tb, Dy, Ho, Er, Tm, Yb, Lu, Sc, Zr, Hf, Ca, and Y, T denotes at least one element selected from the group consisting of V, Nb, Ta, Cr, Mo, Mn, Fe, Co, Al, Ga, Zn, Sn, In, Cu, Si, P, and B, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8; and
an electrically conductive core maintaining the particles.

8. The hydrogen storage alloy electrode according to claim 7, wherein the subscripts a and b satisfy the relationship given by a>b.

9. The hydrogen storage alloy electrode according to claim 8, wherein the subscript a is 0.5 or more.

10. The hydrogen storage alloy electrode according to claim 9, wherein the subscript c is 0.02 or less.

11. The hydrogen storage alloy electrode according to claim 10, wherein the subscript w satisfies the relationship given by 0.10≦w≦0.30.

12. The hydrogen storage alloy electrode according to claim 7, wherein the subscript w satisfies the relationship given by 0.10≦w≦0.30.

13. A nickel metal hydride battery, comprising a hydrogen storage alloy electrode including:
particles made of the hydrogen storage alloy, the alloy having a composition expressed by a general formula:
(LaₐSm_{b}A_{c})_{1-w}Mg_{w}NiₓAl_{y}T_{z},
wherein A denotes at least one element selected from the group consisting of Pr, Nd, Pm, Eu, Gd, Tb, Dy, Ho, Er, Tm, Yb, Lu, Sc, Zr, Hf, Ca, and Y, T denotes at least one element selected from the group consisting of V, Nb, Ta, Cr, Mo, Mn, Fe, Co, Al, Ga, Zn, Sn, In, Cu, Si, P, and B, the subscripts a, b, and c satisfy the relationship given by: a>0; b>0; 0.1>c≧0; and a+b+c=1, and the subscripts w, x, y, and z fall within the range given by: 0.1<w≦1; 0.05≦y≦0.35; 0≦z≦0.5; and 3.2≦x+y+z≦3.8; and
an electrically conductive core maintaining the particles. of claim 6 as a negative electrode.

14. The nickel metal hydride battery according to claim 13, wherein the subscripts a and b satisfy the relationship given by a>b.

15. The nickel metal hydride battery according to claim 14, wherein the subscript a is 0.5 or more.

16. The nickel metal hydride battery according to claim 15, wherein the subscript c is 0.02 or less.

17. The nickel metal hydride battery according to claim 16, wherein the subscript w satisfies the relationship given by 0.10≦w≦0.30.

18. The nickel metal hydride battery according to claim 13, wherein the subscript w satisfies the relationship given by 0.10≦w≦0.30.
